(19) United States
(12) Patent Application Publication
(10) Pub. No.: US 2022/0341739 A1
(43) Pub. Date: Oct. 27, 2022

(54) APPARATUS FOR GENERATING ROUTE OF AUTONOMOUS DRIVING VEHICLE AND METHOD FOR OFFERING SERVICE BY AUTONOMOUS DRIVING VEHICLE

(71) Applicants: HYUNDAI MOTOR COMPANY, Seoul (KR); Kia Corporation, Seoul (KR)

(72) Inventor: Tae Dong OH, Seoul (KR)

(73) Assignees: HYUNDAI MOTOR COMPANY, Seoul (KR); Kia Corporation, Seoul (KR)

(21) Appl. No.: 17/516,129

(22) Filed: Nov. 1, 2021

(30) Foreign Application Priority Data
Apr. 27, 2021 (KR) 10-2021-0054139

(51) Int. Cl. G01C 21/34; G06Q 10/04; G05D 1/02; G06Q 50/30; G06N 3/02

(52) U.S. Cl. CPC G01C 21/3415; G01C 21/3446; G06Q 10/047; G05D 1/0225; G05D 1/0274; G05D 1/0287; G06Q 50/30; G06N 3/02; G05D 2201/0213

(57) ABSTRACT

An apparatus of generating a route of an autonomous driving vehicle may include an information obtaining device to obtain information on a road and information on a demand amount of the autonomous driving vehicle, and a controller to generate a map based on the information obtained from the information obtaining device and to generate a docking point based on the map.

### CROSS-REFERENCE TO RELATED APPLICATION

The present application claims priority to Korean Patent Application No. 10-2021-0054139, filed on Apr. 27, 2021, the entire contents of which is incorporated herein for all purposes by this reference.

### BACKGROUND OF THE INVENTION

### Field of the Invention

The present invention relates to an apparatus of generating a route of an autonomous driving vehicle, and a method for offering a service by an autonomous driving vehicle.

### Description of Related Art

An autonomous driving vehicle refers to a vehicle that recognizes a driving condition to determine a dangerous situation, plans a driving route, and autonomously drives without a driver control. The level of automation of the autonomous driving vehicle is classified into total six levels from level 0 to level 6, in compliance with a guide line (J3026) suggested by the Society of Automotive Engineers (SAE).

Meanwhile, an unmanned autonomous driving vehicle has to autonomously generate a driving route or receive a driving route generated by a server, because the driver control is absent. Accordingly, the driving route of an autonomous driving vehicle has to be efficiently generated by totally considering a complex road situation varying in real time.

The autonomous driving vehicle may provide various services to users. There is required a manner for providing a delivery service, a vehicle sharing service, and a vehicle hailing service of the autonomous driving vehicle.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus of generating a route of an autonomous driving vehicle.

Various aspects of the present invention provide various transportation services to a user by integrally managing an autonomous driving vehicle.

The technical problems to be solved as various exemplary embodiments of the present invention are not limited to the aforementioned problems, and any other technical problems not mentioned herein will be clearly understood from the following description by those skilled in the art to which various exemplary embodiments of the present invention pertains.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, an apparatus of generating a route of an autonomous driving vehicle may include an information obtaining device to obtain information on a road and information on a demand amount of the autonomous driving vehicle, and a controller to generate a map based on the information obtained from the information obtaining device and to generate a docking point based on the map.

According to various exemplary embodiments of the present invention, the information on the road may include at least one of information on a real-time road traffic volume of the road, information on construction of the road, information on an accident section of the road, in which an accident occurs, information on a map of the road, information on a road width of the road, a number of lanes on the road, a number of crossroads on the road, or a number of routes, which allow movement to a nearby area, of the road.

According to various exemplary embodiments of the present invention, the controller may divide the map of the road by a plurality of cells, and generate the map by scoring the plurality of cells, based on the information on the road and the information on the demand amount.

According to various exemplary embodiments of the present invention, the controller may be configured to generate at least one of a first grid map based on the real-time traffic volume of the road, a second grid map based on the demand of demand for the autonomous driving vehicle, and a third map based on accessibility of the road, in which the accessibility of the road is determined based on at least one of the information on the road width of the road, the number of the lanes on the road, the number of the crossroads on the road, or the number of routes, which allow movement to the nearby area, of the road.

According to various exemplary embodiments of the present invention, the controller may be configured to generate a final map based on scores of the cells, which are applied to the first map, the second map, and the third map, and a weight for each situation.

According to various exemplary embodiments of the present invention, the controller may set the weight through one of a machine learning algorithm or a deep learning algorithm.

According to various exemplary embodiments of the present invention, the controller may compare the scores of the plurality of cells included in the final grid map with a threshold value, and may generate, as a docking point, at least one cell having a score higher than the threshold value.

According to various exemplary embodiments of the present invention, the controller may be configured to generate a backbone, which is the shortest route between the docking points, based on the docking points.

According to various exemplary embodiments of the present invention, the controller may be configured to generate the backbone through any one of a machine learning algorithm, a deep learning algorithm, or an algorithm of determining the shortest route.

According to various exemplary embodiments of the present invention, the controller may regenerate the map, the docking points, and the backbone, when arrival of the autonomous driving vehicle at the docking point is determined as being difficult, based on at least one of the construction information of the road or the information on the accident section of the road.

According to various aspects of the present invention, a method for offering a service by an autonomous driving vehicle may include obtaining information on a road from a sensor and obtaining information on a request for use of the autonomous driving vehicle, from the user, generating information on a map, a docking point, and a backbone, based on the obtained information, and controlling the autonomous driving vehicle based on the obtained information and the information on the map, the docking point, and the backbone, which are generated, to offer the service by the autonomous driving vehicle.

According to various exemplary embodiments of the present invention, the controlling of the autonomous driving vehicle to offer the service by the autonomous driving vehicle may include transmitting a command for starting driving and information on the driving to the autonomous driving vehicle.

According to various exemplary embodiments of the present invention, information on a request for the use of the autonomous driving vehicle may include a destination of the user, and the offering of the service by the autonomous driving vehicle by controlling the autonomous driving vehicle may include setting a driving route of the autonomous driving vehicle based on the backbone to a docking point closest to the destination, when the destination is not matched with the docking point, and setting the driving route based on information on the road from the docking point closest to the destination to the destination.

According to various exemplary embodiments of the present invention, the setting of the driving route based on information on the road from the docking point closest to the destination to the destination may include setting a route of the autonomous driving vehicle from the docking point closest to the destination to the destination, through gradient descent, based on the information on the road.

According to various exemplary embodiments of the present invention, the controlling the autonomous driving vehicle to offer the service may include determining whether an article and a person are simultaneously transferred, based on the information on the request for the use of the autonomous driving vehicle, comparing a destination of the article with a destination of the person with each other, and controlling the autonomous driving vehicle to simultaneously transport the article and the person, based on the docking point and the backbone.

According to various exemplary embodiments of the present invention, the controlling of the autonomous driving vehicle to offer the service by the autonomous driving vehicle may include setting a priority for the user, based on the information on a request for the use of the autonomous driving vehicle by the user, and controlling the autonomous driving vehicle based on the priority.

According to various exemplary embodiments of the present invention, the information on the request for the use of the autonomous driving vehicle may include information on riding request by the user. The controlling of the autonomous driving vehicle to offer the service by the autonomous driving vehicle may include determining whether a passenger is present, when the riding request is received from the user, transmitting information on the passenger present to the user, receiving and determining whether the user wants riding together with the passenger, transmitting information on the user to the passenger present, when a request for riding together with the passenger is received from the user, and controlling the autonomous driving vehicle, based on whether the passenger wants riding together with the user.

According to various exemplary embodiments of the present invention, the method may further include the information on the passenger and the information on the user, from the database.

According to various exemplary embodiments of the present invention, the method may further include learning the information on the passenger and the information on the user, through a deep learning module, and transmitting the learned information to the database.

According to various aspects of the present invention, a system to manage an autonomous driving vehicle may include a plurality of autonomous driving vehicles, a sensor to obtain information on a road, a terminal to receive a request for use of the plurality of autonomous driving vehicles by the user, and a server to obtain information on the road from the sensor, to obtain information on the request for the use of the autonomous driving vehicles from the terminal, to generate information on a map, a docking point, and a backbone, and control the plurality of autonomous driving vehicles, based on the information on the road, the information on the request for the use of the autonomous driving vehicle, and the information on the map, the docking point, and the backbone.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a system to manage an autonomous driving vehicle, according to various exemplary embodiments of the present invention;

FIG. 2 is a block diagram illustrating an apparatus of generating a route of an autonomous driving vehicle, according to various exemplary embodiments of the present invention;

FIG. 3 is a view exemplarily illustrating a first grid map generated based on a traffic volume in an apparatus of generating a route of an autonomous driving vehicle, according to various exemplary embodiments of the present invention;

FIG. 4 is a view exemplarily illustrating a first grid map generated based on a demand amount in an apparatus of generating a route of an autonomous driving vehicle, according to various exemplary embodiments of the present invention;

FIG. 5 is a view exemplarily illustrating a first grid map generated based on accessibility in an apparatus of generating a route of an autonomous driving vehicle, according to various exemplary embodiments of the present invention;

FIG. 6 is a view exemplarily illustrating a final grid map generated in an apparatus of generating a route of an autonomous driving vehicle, according to various exemplary embodiments of the present invention;

FIG. 7 is a view exemplarily illustrating a docking point generated in an apparatus of generating a route of an autonomous driving vehicle, according to various exemplary embodiments of the present invention;

FIG. 8 is a view exemplarily illustrating a backbone generated in an apparatus of generating a route of an autonomous driving vehicle, according to various exemplary embodiments of the present invention;

FIG. 9 is a view exemplarily illustrating a docking point and a backbone generated again in an apparatus of generating a route of an autonomous driving vehicle, according to various exemplary embodiments of the present invention;

FIG. 10 is a block diagram illustrating a server to manage an autonomous driving vehicle, according to various exemplary embodiments of the present invention;

FIG. 11 is a view exemplarily illustrating a vehicle driving route generated by a server to manage an autonomous driving vehicle, according to various exemplary embodiments of the present invention;

FIG. 12 is a view exemplarily illustrating a method for generating a route to a destination, which is not matched with the docking point, by a server to manage an autonomous driving vehicle, according to various exemplary embodiments of the present invention;

FIG. 13 is a view exemplarily illustrating types of autonomous driving vehicles depending on driving areas;

FIG. 14 is a flowchart illustrating a method for realizing a together-riding service by a server to manage an autonomous driving vehicle, according to various exemplary embodiments of the present invention;

FIG. 15 is a view exemplarily illustrating a display of a terminal provided to a user based on information transmitted from a server to manage an autonomous driving vehicle, according to various exemplary embodiments of the present invention;

FIG. 16 is a view exemplarily illustrating a display of a terminal provided to a passenger, which is previously present, based on information transmitted from a server to manage an autonomous driving vehicle, according to various exemplary embodiments of the present invention;

FIG. 17 is a flowchart illustrating a method for offering a service by an autonomous driving vehicle service through a server to manage an autonomous driving vehicle;

FIG. 18 is a flowchart illustrating a method for setting a route of an autonomous driving vehicle driving from a departure point to a destination of a user, by a server to manage an autonomous driving vehicle;

FIG. 19 is a flowchart illustrating a method for offering a service when simultaneously transporting an article and a person through an autonomous driving vehicle;

FIG. 20 is a view exemplarily illustrating that an article is transported between autonomous driving vehicles at a docking point.

FIG. 21 is a view exemplarily illustrating that an autonomous driving vehicle transports a plurality of persons and the plurality of articles;

FIG. 22 is a flowchart illustrating a method for offering a together-riding-service in a method for offering an autonomous driving vehicle;

FIG. 23 is a flowchart illustrating a step which is further included in a method for offering an autonomous driving vehicle service; and

FIG. 24 is a block diagram illustrating a system to manage an autonomous driving vehicle.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of well-known features or functions will be ruled out in order not to unnecessarily obscure the gist of the present invention.

Furthermore, in the following description of components according to various exemplary embodiments of the present invention, the terms “first”, “second”, ‘A’, ‘B’, ‘(a)’, and ‘(b)’ may be used. These terms are merely intended to distinguish one component from another component, and the terms do not limit the nature, sequence or order of the constituent components. Furthermore, unless otherwise defined, all terms used herein, including technical or scientific terms, have the same meanings as those generally understood by those skilled in the art to which various exemplary embodiments of the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

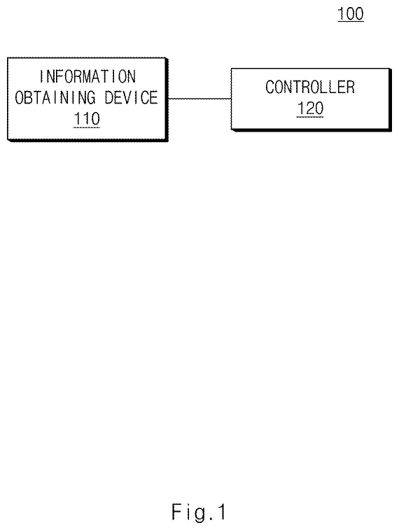

FIG. 1 is a view exemplarily illustrating a system to manage an autonomous driving vehicle, according to various exemplary embodiments of the present invention.

Referring to FIG. 1, a system 10 to manage an autonomous driving vehicle may include a sensor 11, a terminal 12, a plurality of autonomous driving vehicles 13, a server 14, a docking point generating module 15, an inter-docking point backbone generating module 16, a database 17, and a deep learning module 18.

In FIG. 1, the docking point generating module 15 and the inter-docking point backbone generating module 16 are illustrated separately from the server 14 for the illustrative purpose. According to various exemplary embodiments of the present invention, the server 14 may include the docking point generating module 15 and the inter-docking point backbone generating module 16. According to another exemplary embodiment of the present invention, the docking point generating module 15 and the inter-docking point backbone generating module 16 may be included in the plurality of autonomous driving vehicles 13. However, it may be more efficient that the server 14 includes the docking point generating module 15 and the inter-docking point backbone generating module 16 in the system 10 to manage the autonomous driving vehicle.

Furthermore, although FIG. 1 illustrates that the database 17 and the deep learning module 18 are separate from the server 14, the present invention is not limited thereto. For example, the server 14 may include the database 17 and the deep learning module 18.

According to various exemplary embodiments of the present invention, the server 14 may include the docking point generating module 15, the inter-docking point backbone generating module 16, the database 17, and the deep learning module 18.

The sensor 11 may obtain information related to a road. For example, the sensor 11 may obtain at least one of information on a traffic volume of a road, information on the construction of the road, or information on a section (accident section) of the road, in which an accident occurs, from at least one of a road-provided camera or a government office. The sensor 11 may transmit the obtained information to the server 14.

The terminal 12 may receive information on a request (using request) for the use of a plurality of autonomous driving vehicles 13 by a user. For example, the terminal 12 may include a mobile phone, a personal computer (PC), and a kiosk. The terminal 12 may transmit information on the using request by the user, to the server 14, and may receive a response to the using request from the server 14.

The plurality of autonomous driving vehicles 13 may drive based on information obtained from the server 14. For example, the plurality of autonomous driving vehicles 13 may drive based on at least one of a driving start command, a departure point, a destination, a stopover, a map, or a driving route obtained from the server 14. Furthermore, the plurality of autonomous driving vehicles 13 may autonomously recognize a surrounding situation, and may drive based on the recognized surrounding situation.

The server 14 may obtain information on the road from the sensor 11. Furthermore, the server 14 may obtain information on a using request of the autonomous driving vehicle, from the terminal 12.

According to various exemplary embodiments of the present invention, the server 14 may control the plurality of autonomous driving vehicles 13, based on information determined or obtained from the docking point generating module 15, the inter-docking point backbone generating module 16, the database 17, and the deep learning module 18. For example, the server 14 may transmit a driving start command information on the driving of the vehicle, to the plurality of autonomous driving vehicles 13, and the plurality of autonomous driving vehicles 13 may drive, based on the information received from the server 14.

The docking point generating module 15 may generate a grid map, and may generate a docking point based on the determined grid map. For example, the docking point generating module 15 may obtain information, which is necessary to generate the grid map and the docking point, from the server 14, may generate the grid map and the docking point based on the obtained information, and may transmit the generated grid map and the generated docking point to the inter-docking point backbone generating module 16. According to various exemplary embodiments of the present invention, the docking point generating module 15 may generate the grid map and the docking point, by obtaining the information on the road and information on the using request of the autonomous driving vehicle, from the server 14.

The inter-docking point backbone generating module 16 may generate a backbone, based on the generated grid map and the generated docking point. For example, the inter-docking point backbone generating module 16 may generate a backbone to make the shortest distance between docking points which are generated. For another example, the inter-docking point backbone generating module 16 may generate a backbone to require the shortest time to move between the docking points which are generated. According to various exemplary embodiments of the present invention, the inter-docking point backbone generating module 16 may transmit, to the server 14, information on the grid map, the docking point, and the backbone, which are generated, and may control the plurality of autonomous driving vehicles 13, based on the information received from the server 14.

The database 17 may store information on users of the plurality of autonomous driving vehicles 13. For example, the database 17 may store information on a gender, an age, and a riding manner of each user. According to various exemplary embodiments of the present invention, the database 17 may transmit the information on each user to the server 14, when the server 14 requests for the information on the user.

The deep learning module 18 may learn information on users. For example, the deep learning module 18 may learn at least one of the age or the gender of each user, based on information on an image of each user. According to various exemplary embodiments of the present invention, the deep learning module 18 may transmit the learned information to the database 17.

The system 10 to manage the autonomous driving vehicle may allow the user to perform efficient driving by integrally controlling the plurality of autonomous driving vehicles 13, as the server 14, which has information obtained from the sensor 11 and the terminal 12, generates information on the driving of the plurality of autonomous driving vehicles 13.

According to another exemplary embodiment of the present invention, the system 10 to manage the autonomous driving vehicle may allow the server 14 to include the docking point generating module 15, the inter-docking point backbone generating module 16, the database 17, and the deep learning module 18. In other words, the server 14 may perform all the functions of the docking point generating module 15, the inter-docking point backbone generating module 16, the database 17, and the deep learning module 18.

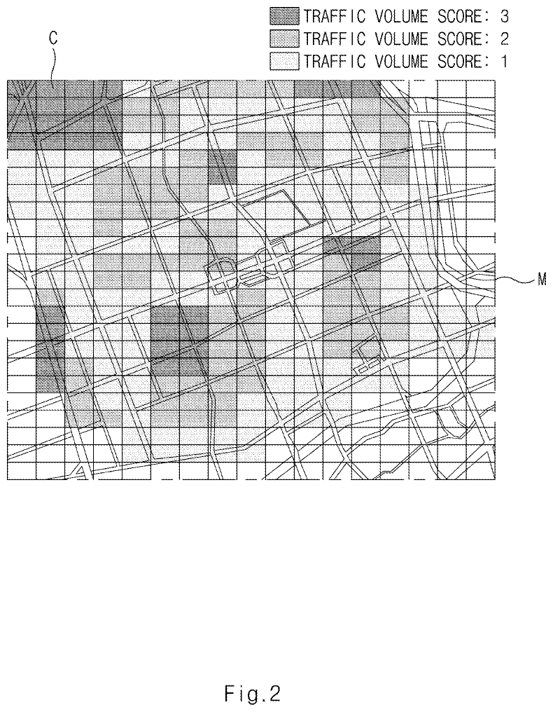

FIG. 2 is a block diagram illustrating an apparatus of generating a route of an autonomous driving vehicle, according to various exemplary embodiments of the present invention.

Referring to FIG. 2, an apparatus 100 for generating a route of an autonomous driving vehicle may include an information obtaining device 110 and a controller 120.

According to various exemplary embodiments of the present invention, the apparatus 100 for generating the route of the autonomous driving vehicle may include the docking point generating module 15 and the inter-docking point backbone generating module 16. According to another exemplary embodiment of the present invention, the server 14 of FIG. 1 may include the apparatus 100 for generating the route of the autonomous driving vehicle. According to various exemplary embodiments of the present invention, the apparatus 100 for generating the route of the autonomous driving vehicle may be included in each of the plurality of autonomous driving vehicles 13 illustrated in FIG. 1.

The information obtaining device 110 may obtain information related to a road. For example, the information on the road may include at least one of information on a real-time traffic volume of a road, information on the construction of the road, information on an accident section of the road, information on a map of the road, information on a width of the road, a number of lanes on the road, a number of crossroads on the road, or a number of routes, which allow movement to a nearby area, of the road.

The information obtaining device 110 may obtain information on an amount (demand amount) of demand for the autonomous driving vehicle. For example, the information obtaining device 110 may obtain information on an amount of requests for use of the autonomous driving vehicle by a user for each region.

Meanwhile, the information obtaining device 110 may directly obtain the information on the road, from the sensor 11 or from the server 14. Furthermore, the information obtaining device 110 may directly obtain information on the demand amount of the autonomous driving vehicle, from the user or the server 14.

The controller 120 may divide a map of the road into a plurality of cells. For example, the size of the plurality of cells divided by the controller 120 may be a preset value.

The controller 120 may generate a map by scoring the plurality of cells, based on the information on the road and the information on the demand amount. For example, the map may be a grid map. Hereinafter, the map will be referred to as the grid map for the explanation.

The controller 120 may generate a first grid map based on the real-time traffic volume of the road and may generate a second grid map based on the demand amount for the autonomous driving vehicle. Furthermore, the controller 120 may determine the accessibility of the road, based on at least one of information on the road width of the road, a number of lanes on the road, a number of crossroads on the road, or a number of routes, which allow movement to a nearby area, of the road, and may generate a third grid map, based on the accessibility of the road.

Meanwhile, the controller 120 may always generate at least one of the first grid map, the second grid map, or the third grid map. However, although the controller 120 generates the first grid map, the second grid map, and the third grid map, the present invention is not limited thereto. For example, the controller 120 may further generate another grid map based on another piece of information.

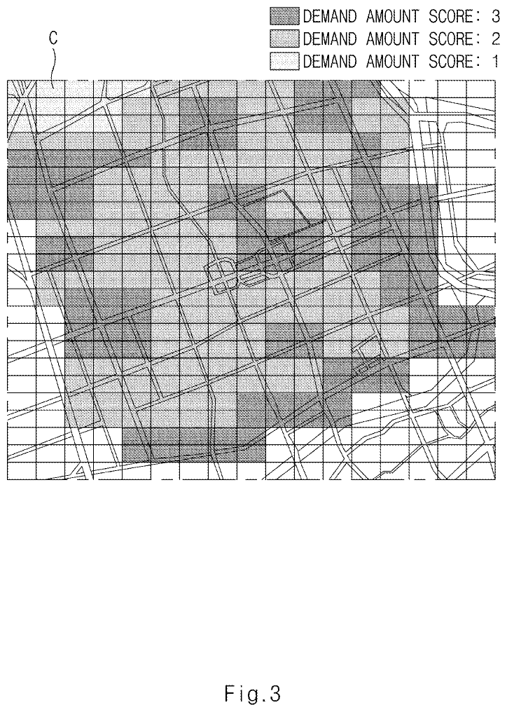

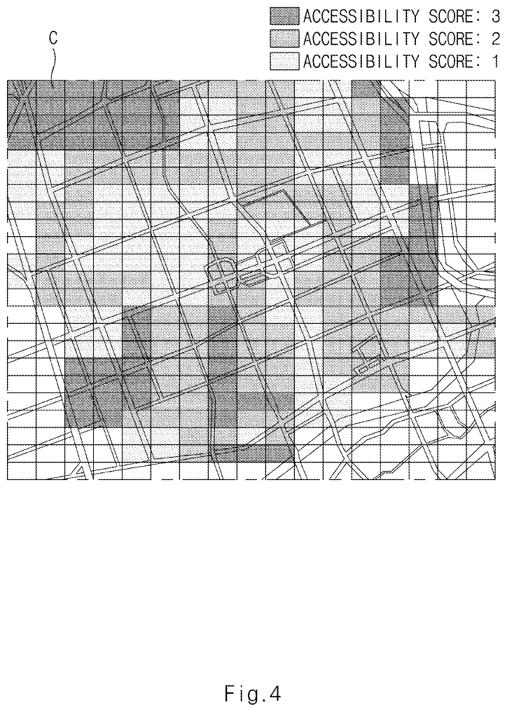

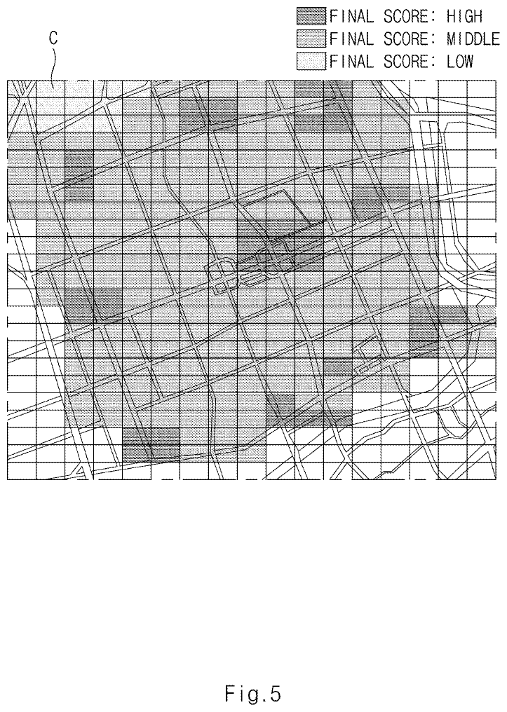

Hereinafter, the details of the grid map generated by the controller 120 will be described in more detail with reference to FIG. 3, FIG. 4, and FIG. 5.

FIG. 3 is a view exemplarily illustrating a first grid map generated based on a traffic volume in an apparatus of generating a route of an autonomous driving vehicle, according to various exemplary embodiments of the present invention.

Referring to FIG. 3, the controller 120 may divide a map “M” into cells “C”. The controller 120 may score the cell “C”. For example, the controller 120 may score the cell “C” based on the traffic volume. In the instant case, the controller 120 may assign a lower score to the cell “C” with respect to a smaller traffic volume, and may assign a higher score to the cell “C” with respect to a larger traffic volume. Furthermore, the controller 120 may assign a traffic volume score to each cell “C” by dividing the maximum average daily traffic amount by a current traffic volume with respect to each cell “C”.

Although FIG. 3 illustrates that the controller 120 assigns point 1, point 2, and point 3 to the cell “C” by classifying the traffic volume score of the cell “C” by three sections, the present invention is not limited thereto. The traffic volume score of the cell “C” may be assigned with an integer number or a real number.

FIG. 4 is a view exemplarily illustrating a second grid map generated based on a demand amount in an apparatus of generating a route of an autonomous driving vehicle, according to various exemplary embodiments of the present invention.

Referring to FIG. 4, the controller 120 may score cells “C”, based on a demand amount. For example, the controller 120 may assign a higher score to a cell C having a larger demand amount, and may assign a lower score to a cell C having a smaller demand amount. The controller 120 may assign a demand amount score to each cell “C” by dividing the average hourly demand amount by a current demand amount with respect to each cell “C”.

Although FIG. 4 illustrates that the controller 120 assigns point 1, point 2, and point 3 to the cell “C” by classifying the demand amount score of the cell “C” by three sections, the present invention is not limited thereto. The demand amount score of the cell “C” may be assigned with an integer number or a real number.

FIG. 5 is a view exemplarily illustrating a third grid map generated based on accessibility in an apparatus of generating a route of an autonomous driving vehicle, according to various exemplary embodiments of the present invention.

Referring to FIG. 5, the controller 120 may score the cells “C”, based on the accessibility to the cells “C”. For example, the controller 120 may assign higher scores to a cell “C” having a wider width, a cell “C” having a larger number of lanes, a cell “C” having a larger number of crossroads, and a cell “C” having a larger number of routes that allow the movement to a nearby area. Furthermore, the controller 120 may quantitatively score cells “C” by uniformly dividing scores of remaining cells “C” other than a cell “C”, which has the highest accessibility score in the total cells “C,” by the score of the cell “C” having the highest accessibility score.

Although FIG. 5 illustrates that the controller 120 assigns point 1, point 2, and point 3 to the cell “C” by classifying the accessibility score of the cell “C” by three sections, the present invention is not limited thereto, the accessibility score of the cell “C” may be assigned with an integer number or a real number.

Referring back to FIG. 2, the controller 1 may generate a final grid map, based on scores and weights for each situation, which are applied to cells in the first grid map, the second grid map, and the third grid map. For example, the controller 120 may set a first weight to the first grid map, may set a second weight to the second grid map, and may set a third weight to the third grid map. Furthermore, the controller 120 may generate the final grid map, based on the set weight, by multiplying the first weight to the score of each cell included in the first grid map, multiplying the second weight to the score of each cell included in the second grid map, and multiplying the third weight to the score of each cell included in the third grid map and by adding up the scores of the cells.

Meanwhile, the controller 120 may set a weight corresponding to each grid map in advance or may set the weight to be varied in each time period. For example, the controller 120 may generate the final grid map by setting the second weight of the second grid map, which is generated based on the demand amount, and the third weight of the third grid map, which is generated based on the accessibility, to be higher, in a time period representing a larger traffic volume.

Furthermore, the controller 120 may learn a manner of setting the weight to set the optimal weight. For example, the controller 120 may learn the manner of setting the weight through one of a machine learning algorithm or a deep learning algorithm. For another example, the controller 120 may learn the weight by using one of reinforcement learning, a long short-term memory model (LSTM), or a convolutional neural network (CNN)

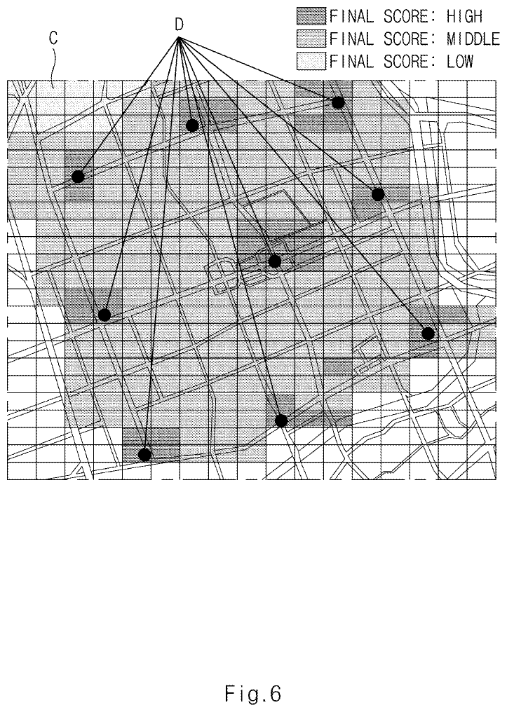

Hereinafter, the final grid map generated by the controller 120 will be described with reference to FIG. 6.

FIG. 6 is a view exemplarily illustrating the first grid map generated in the apparatus of generating a route of an autonomous driving vehicle, according to various exemplary embodiments of the present invention.

Referring to FIG. 6, the controller 120 may generate a final grid map by multiplying and adding up the weights set to the cells C of the generated first grid map, the second grid map, and the third grid map. For example, the controller 120 may set “1” as the first weight for the first grid map generated based on the traffic volume, and may set “0” as the second weight and the third weight of the second grid map and the third grid map. Accordingly, the final grid map may be generated based on only the first grid map. Furthermore, the controller 120 may generate the final grid map by combining two or more grid maps by assigning weights to two or more grid maps.

Although FIG. 6 illustrates that the scores of the cells “C” in the final grid map are expressed as ‘high’, ‘middle’, and ‘lower’, but the present invention is not limited thereto. In other words, the controller 120 may determine the score of each cell C to an integer number or a real number in the final grid map.

Referring back to FIG. 2, the controller 120 may generate a docking point based on scores of cells included in the final grid map. For example, the controller 120 may compare the scores of the plurality of cells included in the final grid map with a threshold value, and may generate, as the docking point, at least one cell having a score higher than the threshold value.

According to various exemplary embodiments of the present invention, the docking point may be an area for the transfer of the autonomous driving vehicles. For example, since the docking point is a cell generated based on the final grid map, the autonomous driving vehicles may easily access the docking point.

According to another exemplary embodiment of the present invention, the docking point may be a place in which autonomous driving vehicles stand by. For example, since the docking point may have higher probability in demand amount, the autonomous driving vehicle may stand by in the docking point and may wait for the using request by users.

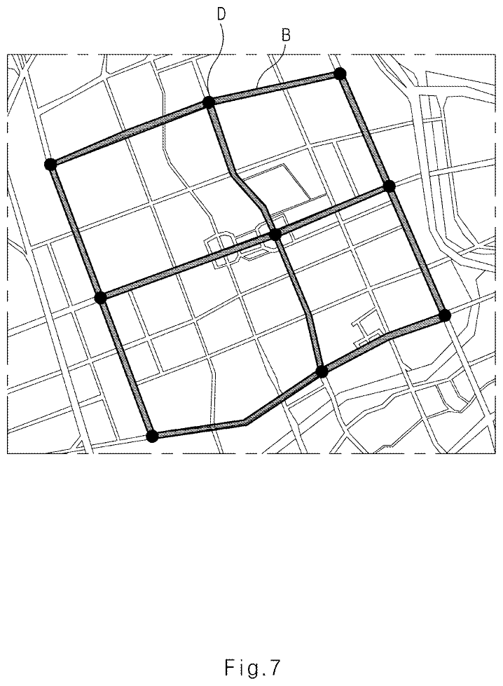

Hereinafter, an example of a docking point generated by the controller 120 will be described in detail with reference to FIG. 7.

FIG. 7 is a view exemplarily illustrating a docking point generated in an apparatus of generating a route of an autonomous driving vehicle, according to various exemplary embodiments of the present invention.

Referring to FIG. 7, the controller 120 may generate a docking point “D” of cells “C” included in the final grid map. For example, the controller 120 may generate the docking point “D” from among cells C included in the final grid map and having a score greater than or equal to the threshold value.

For another example, the controller 120 may generate the docking point “D” from among cells “C” included in the final grid map and having a score of ‘high’. The controller 120 does not need to generate the docking point “D” by use of all cells “C” having the score of ‘high’. For example, the controller 120 may generate the docking point “D” by additionally considering information, such as a road availability status, on the road.

In the instant case, although FIG. 7 illustrates that the docking point “D” is generated through the selection from among the cells ‘C’ having the score of ‘high’, the present invention is not limited thereto. For example, the controller 120 may assign a score, which is formed with an integer number or a real number, to a cell “C”, and may generate the docking point “D” through the selection from among the cells “C”.

Referring back to FIG. 2, the controller 120 may generate a backbone which is the shortest route between the docking points, based on the docking points. For example, the controller 120 may generate the backbone based on the distance between the docking points, or may generate the backbone based on the time required for movement.

In the instant case, the controller 120 may generate the backbone through any one of a machine learning algorithm, a deep learning algorithm, or an algorithm of determining the shortest route. For example, the controller 120 may generate the backbone through a Dijkstra Algorithm or an A* Algorithm. However, the present invention is not limited to the above manner, and the controller 120 may generate the backbone between docking points through various manners.

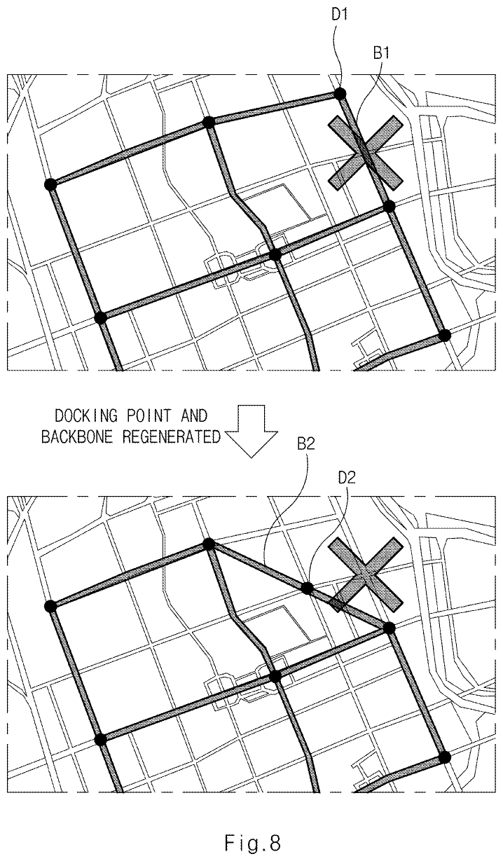

Hereinafter, the backbone generated by the controller 120 will be described with reference to FIG. 8.

FIG. 8 is a view exemplarily illustrating a backbone generated in an apparatus of generating a route of an autonomous driving vehicle, according to various exemplary embodiments of the present invention.

Referring to FIG. 8, the controller 120 may generate a backbone “B” which is the shortest route between the generated docking points “D”. For example, since the route from each docking point “D” to the closest docking point “D” is a straight route, the controller 120 may generate the backbone. The controller 120 may generate a backbone through a fixed route that efficiently connects between the docking points “D”. Since the backbone is the fixed route, only an autonomous driving vehicle in a lower level (e.g., level 3) may be drive on the fixed route.

Referring back to FIG. 2, the controller 120 may determine whether the arrival of the vehicle at the docking point is difficult, based on at least one of information on the construction of the road and the information on the accident section of the road. For example, when the generated docking point is under construction and thus the vehicle fails to pass through the docking point, the controller 120 may determine that the arrival of the vehicle at the docking point is difficult.

The controller 120 may generate (regenerate) a grid map, a docking point, or a backbone again when the arrival of the vehicle at the generated docking point is difficult. For example, when determining that the arrival of the vehicle is difficult at any one docking point which is generated, the controller 120 may generate a grid map, a docking point, and a backbone again, other than a docking point making it difficult the autonomous driving vehicle to arrive at the docking point.

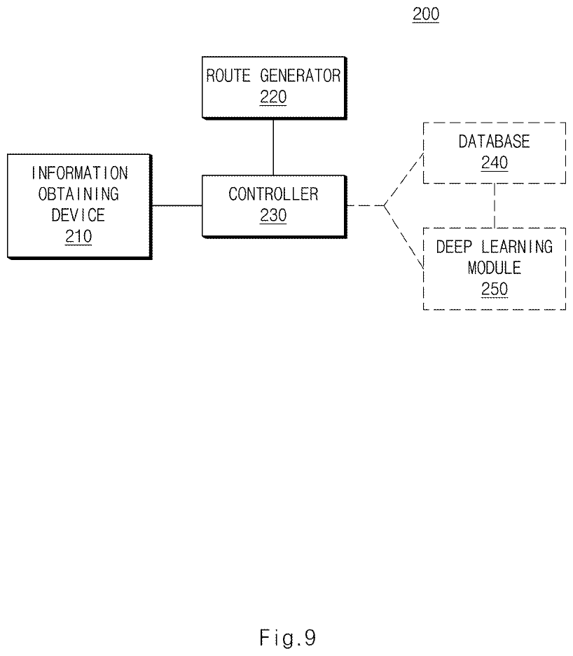

Hereinafter, a docking point and a backbone generated by the controller 120 again will be described with reference to FIG. 9.

FIG. 9 is a view exemplarily illustrating a docking point and a backbone generated again in an apparatus of generating a route of an autonomous driving vehicle, according to various exemplary embodiments of the present invention.

Referring to FIG. 9, the controller 120 may determine a docking point “D1” or a backbone “B1” making it difficult for a vehicle to arrive at the docking point “D1” or the backbone “B1”, when obtaining the information on the construction or the information on the accident section. The controller 120 may generate the grid map again when the docking point “D1” or the backbone “B1” making it difficult for the vehicle to the docking point “D1” or the backbone “B1” is prevent. Accordingly, the controller 120 may generate the docking point and the backbone, again. In other words, the controller 120 may exclude the docking point “D1” and the backbone “B1” affected by the construction or the accident section, and may generate a docking point “D2” and a backbone “B2” again.

According to various exemplary embodiments of the present invention, the apparatus of generating the route of the autonomous driving vehicle may generate a grid map, a docking point, and a backbone by performing operations of the information obtaining device 110 and the controller 120. The apparatus 100 for generating the route of the autonomous driving vehicle may generate a plurality of grid maps by the controller 120, based on information obtained from the information obtaining device 110, may generate the final grid map by applying a weight to each grid map, may generate a docking point, based on the final grid map, and may generate a backbone connecting between docking points.

The apparatus 100 for generating the route of the autonomous driving vehicle may generate a route allowing an autonomous driving vehicle to efficiently drive, based on information on the demand amount of the autonomous driving vehicle and information on a road situation. Furthermore, the autonomous driving vehicles may be controlled based on the docking point and the backbone generated in the apparatus 100 for generating the route of the autonomous driving vehicle. In other words, the autonomous driving vehicles may provide, to a user, a transportation service based on the efficient route.

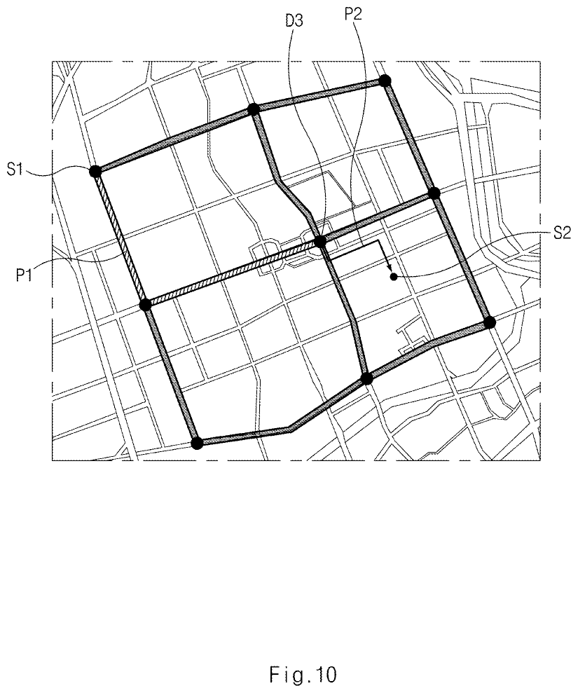

Hereinafter, a server to manage an autonomous driving vehicle will be described in detail with reference to FIG. 10.

FIG. 10 is a block diagram illustrating a server to manage an autonomous driving vehicle, according to various exemplary embodiments of the present invention.

Referring to FIG. 10, a server 200 to manage an autonomous driving vehicle may include an information obtaining device 210, a route generator 220, and a controller 230.

According to various exemplary embodiments of the present invention, the server 200 to manage the autonomous driving vehicle may include the apparatus 100 for generating the route of the autonomous driving vehicle in FIG. 2. For example, the route generator 220 in the server 200 to manage the autonomous driving vehicle may be substantially the same as the apparatus 100 for generating the route of the autonomous driving vehicle.

According to another exemplary embodiment of the present invention, the server 200 to manage the autonomous driving vehicle may include the server 14 of FIG. 1, the docking point generating module 15, the inter-docking point backbone generating module 16, the database 17, and the deep learning module 18. For example, the route generator 220 may include the docking point generating module 15, and the inter-docking point backbone generating module 16. A database 240 may be the substantially same as the database 17, and a deep learning module 250 may be the substantially same as the deep learning module 18.

The information obtaining device 210 may obtain the information on the road from the sensor. For example, the information obtaining device 210 may obtain at least one of information on a real-time traffic volume of a road, information on construction of the road, information on an accident section of the road, information on a map of the road, information on a road width of the road, a number of lanes on the road, a number of crossroads on the road, or a number of routes, which allow movement to a nearby area, of the road.

The information obtaining device 210 may obtain information on an amount (demand amount) of demand for the autonomous driving vehicle. For example, the information obtaining device 210 may obtain, from a user, at least one of a departure point, a destination, a riding request, a together-riding request, or information on the user.

The route generator 220 may generate information on a grid map, a docking point, and a backbone, based on information obtained from the information obtaining device 210. For example, the route generator 220 may generate the information on the grid map, the docking point, and the backbone, based on information on the road and information on the demand amount of the autonomous driving vehicle.

The route generator 220 may generate information on a grid map, a docking point, or a backbone again, when obtaining the information on the accident on the road or information on a section of the road under construction. For example, the route generator 220 may generate information on the grid map, the docking point, and the backbone again, other than a docking point or a backbone making it difficult for the vehicle to arrive at the docking point or the backbone, when it is determined, based on the information on the accident on the road or the information on the section of the road under construction, that the docking point or the backbone making it difficult for the vehicle to arrive at the docking point or the backbone is present.

The controller 230 may control the autonomous driving vehicle based on the information obtained from the information obtaining device 210 and the information generated from the route generator 220. For example, the controller 230 may control the autonomous driving vehicle by transmitting, to the autonomous driving vehicle, a command for starting driving and information on the driving.

The controller 230 may set a driving route of the autonomous driving vehicle to a docking point closest to a destination based on the backbone, when the destination of the user is not matched with the docking point. For example, the controller 230 may set a backbone generated by the route generator 220, as a driving route of the autonomous driving vehicle to a docking point representing the shortest distance or a docking point, which represents the shortest time to the destination, when the destination is not matched with the docking point.

The controller 230 may set the driving route from the docking point, which is closest to the destination, to the destination, based on information on the road. For example, the controller 230 may set a route from the docking point, which is closest to the destination, to the destination through Gradient Descent, based on information on the road.

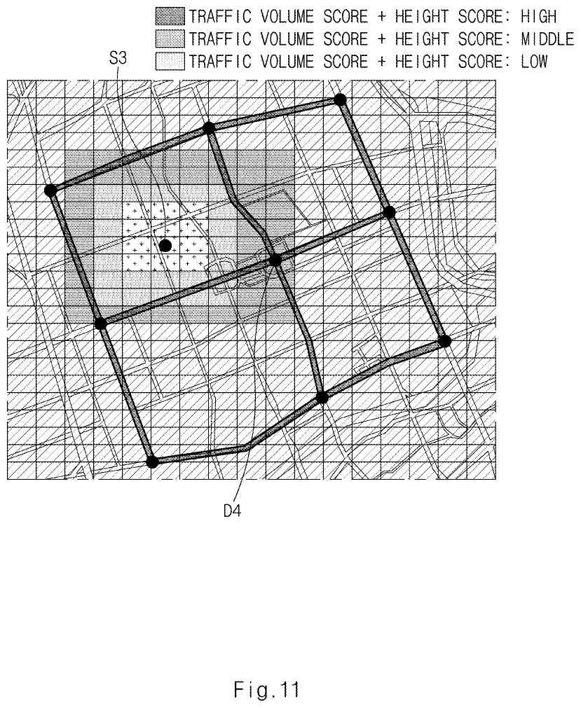

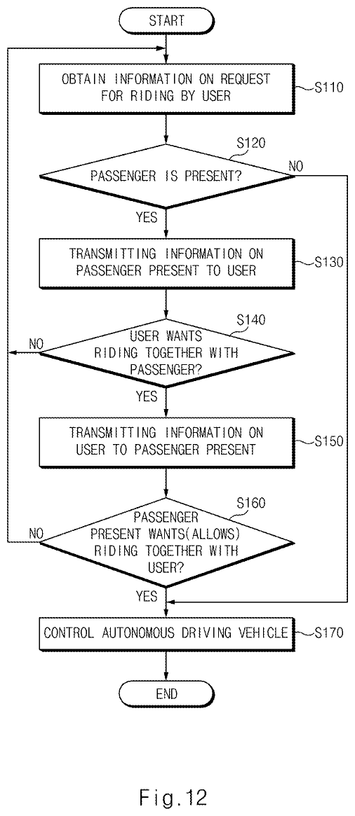

Hereinafter, a method that the controller 230 sets a driving route of an autonomous driving vehicle will be described in detail with reference to FIG. 11 and FIG. 12.

FIG. 11 is a view exemplarily illustrating a vehicle driving route generated by a server to manage an autonomous driving vehicle, according to various exemplary embodiments of the present invention.

Referring to FIG. 11, the server 200 may receive a request for the use of an autonomous driving vehicle from a departure point “S1” to a destination “S2” by a user. In the instant case, the controller 230 may set a driving route of an autonomous driving vehicle from the departure point “S1” to the destination “S2”. For example, the controller 230 may set a docking point “D3” closest to the destination “S2”, based on a docking point, which is generated by the route generator 220, and may set a driving route “P1” from the departure point “S1” to the docking point “D3” closest to the destination “S2”, based on a backbone generated by the route generator 220. Furthermore, the controller 230 may set a driving route “P2” from the docking point “D3” closest to the destination to the destination “S2”, based on information on a road, which is obtained from the information obtaining device 210.

Hereinafter, a method for setting the driving route “P2” from the docking point “D3”, which is closest to the destination “S2”, to the destination “S2” will be described in detail with reference to FIG. 12.

FIG. 12 is a view exemplarily illustrating a method for generating a route to a destination, which is not matched with a docking point, by a server to manage an autonomous driving vehicle, according to various exemplary embodiments of the present invention.

Referring to FIG. 12, the controller 230 may set the driving route of the autonomous driving vehicle from a departure point “D4”, which is closest to the destination “S3”, to the destination “S3”. For example, the controller 230 may determine a score (height score) for heights of cells, and may add up the height scores and the traffic volume score of the road to score the cells. In the instant case, the controller 230 may assign the highest height score to the departure point “D4” and may assign a lower score to a point closer to the destination “S3”. In other words, the controller 230 may set a driving route of the autonomous driving vehicle through a Gradient Descent scheme, based on a result obtained by adding the height score and the traffic volume score of the road. [[

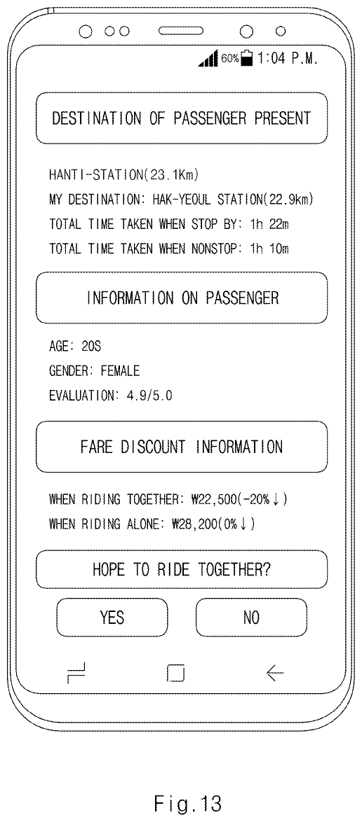

FIG. 13 is a view exemplarily illustrating the type of autonomous driving vehicles depending on driving areas.

Referring to FIG. 13, the controller 230 may generate a backbone “B3” between docking points “D5” and “D6”. In the instant case, since the backbone “B3” is a preset fixed route, an autonomous driving vehicle in a lower level may drive on the backbone. For example, the controller 230 may set an autonomous driving vehicle driving on the backbone “B3” between the docking points “D5” and “D6”, as an autonomous driving vehicle in level 3.

For another example, in an area “A” in which the autonomous driving vehicle has to drive on an arbitrary route other than the backbone “B3”, since the autonomous driving vehicle has to autonomously determine the arbitrary route and drive on the arbitrary route. Accordingly, the area “A” requiring the driving on the arbitrary route requires the driving of the autonomous driving vehicle in a higher level. For example, the controller 230 may set, to an autonomous driving vehicle in level 4, a vehicle driving in the area requiring the driving on the arbitrary route.

Referring back to FIG. 10, the controller 230 may provide a together-riding service of an autonomous driving vehicle to a user. For example, the controller 230 may receive a request for riding from a user, may determine whether a passenger is present, may provide information on the passenger to the user, when the passenger is present, and may receive, from the user, a request for riding together with the passenger. Furthermore, the controller 230 may provide information on the user to the passenger present, when the request for riding together with the passenger is received from the user, and may control the autonomous driving vehicle based on whether the passenger wants (allows) riding together with the user.

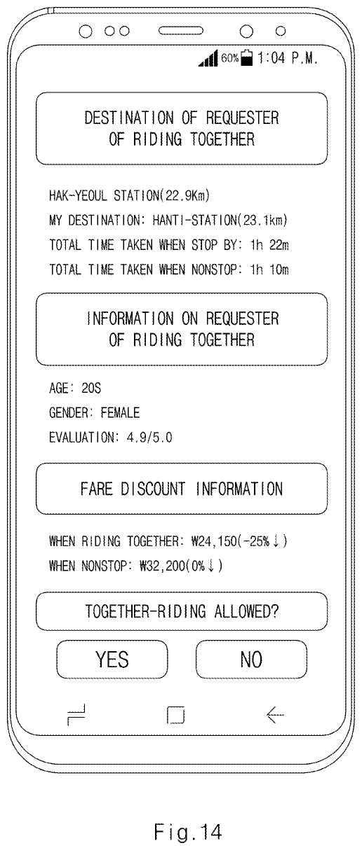

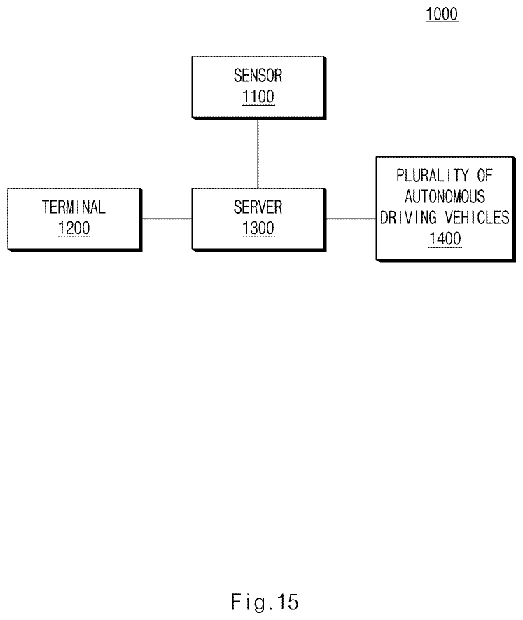

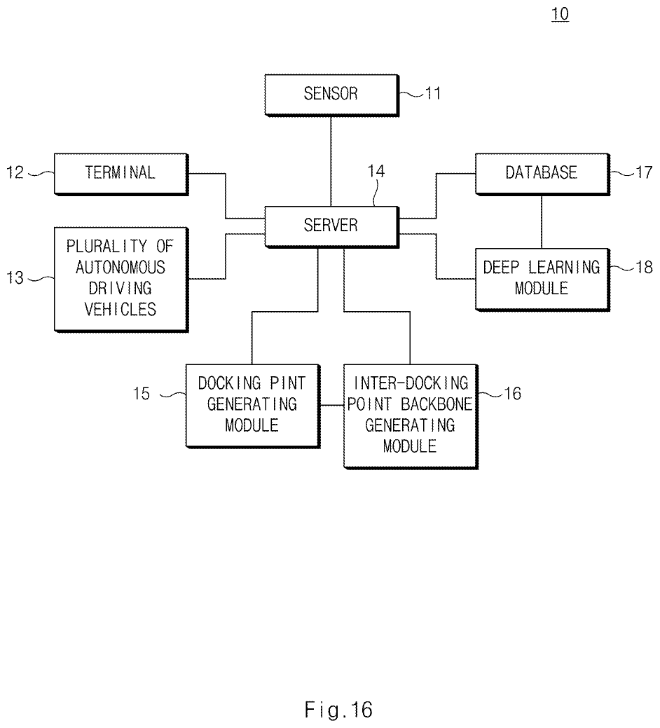

Hereinafter, a method that the controller 230 provides the together-riding service of the autonomous driving vehicle will be described in detail with reference to FIG. 14, FIG. 15 and FIG. 16.

FIG. 14 is a flowchart illustrating a method for realizing a together-riding service by a server to manage an autonomous driving vehicle, according to various exemplary embodiments of the present invention.

Referring to FIG. 14, the method that the controller 230 provides the together-riding service of the autonomous driving vehicle may include the steps of obtaining information on the request for riding by the user (S110), determining whether the passenger is present (S120), transmitting information on the passenger present to the user (S130), receiving and determining whether the user wants riding together with the passenger (S140), transmitting information on the user to the passenger present (S150), receiving and determining whether the passenger present wants (allows) riding together with the user (S160), and controlling the autonomous driving vehicle (S170).

In the step of obtaining the information on the request for riding by the user (S110), the information obtaining device 210 may obtain information on the request (riding request) for riding of the autonomous driving vehicle, from the user, and the controller 230 may obtain the information on the riding request from the information obtaining device 210.

In the step of determining whether the passenger is present (S120), the controller 230 may determine whether an autonomous driving vehicle is present around the user, and may determine whether the passenger is present in the autonomous driving vehicle around the user. For example, the controller 230 may control the autonomous driving vehicle to perform a procedure of riding a new passenger on an autonomous driving vehicle, when the autonomous driving vehicle having no passenger is present around the user.

In the step of transmitting of the information on the passenger present to the user (S130), the controller 230 may transmit information on the passenger, which is present in the autonomous driving vehicle around the user, to the user, when the passenger is present in the autonomous driving vehicle around the user. For example, the information on the passenger may include an age, a gender, a destination, or information the evaluation for the passenger. Furthermore, the controller 230 may provide information on fare discount to the user, when the user rides together with the passenger.

In the step of receiving and determining whether the user wants riding together with the passenger (S140), the controller 230 may receive a request related to whether the user wants riding together with the passenger, from the user, and may determine whether the user wants riding together with the passenger. For example, the controller 230 may terminate the together-riding service, and may perform the procedure of riding on a new autonomous driving vehicle around the user, when a request for rejection of riding together with the passenger is received from the user.

In the step of transmitting the information on the user to the passenger present (S150), the controller 230 may transmit the information on the user to the passenger when receiving the request for the riding together with the passenger. For example, the information on the user may include an age, a gender, a destination, or information on the evaluation for the passenger. Furthermore, the controller 230 may provide information on fare discount to the user when the user rides together with the passenger.

In the step of receiving and determining whether the passenger present wants (allows) riding together with the user (S160), the controller 230 may receive and determine whether the passenger wants (allows) riding together with the user. For example, the controller 230 may receive a request for the rejection of the riding together with the user, from the passenger. When the request for the rejection of the riding is present, the controller 230 may perform a procedure of riding on another autonomous driving vehicle around the user.

In the step of controlling the autonomous driving vehicle (S170), the controller 230 may control the autonomous driving vehicle based on a request that the passenger wants (allows) riding together with the user, when the request that the passenger wants (allows) riding together with the user is present. For example, the controller 230 may establish a driving route of the autonomous driving vehicle again, and may control the autonomous driving vehicle such that the user rides on the autonomous driving vehicle.

Furthermore, in the step of controlling the autonomous driving vehicle (S170), the controller 230 may control an autonomous driving vehicle around the user such that the user rides on the autonomous driving vehicle, when a passenger is not present on the autonomous driving vehicle. In other words, the user may newly ride on the autonomous driving vehicle.

Hereinafter, displays of terminals provided to a user and a passenger, which is present, based on information transmitted from the server 200 to manage an autonomous driving vehicle will be described with reference to FIG. 15 and FIG. 16.

FIG. 15 is a view exemplarily illustrating a display of a terminal provided to a user based on information transmitted from the server to manage the autonomous driving vehicle, according to various exemplary embodiments of the present invention.

Referring to FIG. 15, the terminal of the user may provide information on a destination of the passenger, information on the passenger, and information on fare discount.

The information on the destination of the passenger may include information on the destination of the passenger, time taken to stop by the destination of the passenger and time taken when driving to the destination of the user nonstop.

The information on the passenger may include at least one of the age of the passenger, the gender of the passenger, or the information on the evaluation for the passenger.

The information on the fare discount may include a fare provided through the discount when the user rides together with the passenger, and a fare when the user newly rides.

The user may input whether to wants riding together with the passenger, after recognizing information on the destination of the passenger, information on the passenger, and the information on the fare discount on the terminal of the user.

FIG. 16 is a view exemplarily illustrating a display of a terminal provided to a user based on information transmitted from a server to manage an autonomous driving vehicle, according to various exemplary embodiments of the present invention.

Referring to FIG. 16, the terminal of the passenger may provide information on a destination of the user, information on the user, and information on fare discount.

The information on the destination of the user may include information on the destination of the user, time taken to stop by the destination of the user and time taken when driving to the destination of the passenger nonstop.

The information on the user may include at least one of the age of the user, the gender of the user, or the information on the evaluation for the user.

The information on the fare discount may include a fare provided through the discount when the passenger rides together with the user, and a fare when the passenger rejects the riding of the user.

The passenger may input whether to want riding together with the user, after recognizing information on the destination of the user, information on the user, and the information on fare discount on the terminal of the passenger.

Accordingly, the server 200 to manage the autonomous driving vehicle may provide, to the user, the together-riding service. Accordingly, the server 200 to manage the autonomous driving vehicle may efficiently drive the autonomous driving vehicle.

Referring back to FIG. 10, according to various exemplary embodiments of the present invention, the server 200 to manage the autonomous driving vehicle may further include the database 240 and the deep learning module 250.

The database 240 may store the information on users of the autonomous driving vehicle. For example, the database 240 may store at least one of ages, genders, or information on the evaluation for the users of the autonomous driving vehicle.

Meanwhile, the controller 230 may obtain the information on the user and the information on the passenger, from the database 240. In other words, the controller 230 may provide, to the user, information on the passenger, which is obtained from the database 240, and may provide the obtained information of the user to the passenger. Accordingly, the controller 230 may support the together-riding service of the autonomous driving vehicle.

The deep learning module 250 may be linked with the database 240, and may receive and process information on the user and the passenger. For example, the deep learning module 250 may receive images of the user and the passenger or the information on the user and the passenger from the controller 230. The deep learning module 250 may process the images of the user and the passenger or the information on the user and the passenger, may infer the age and the gender of the passenger, and may transmit the inferred result to the database 240.

In other words, the controller 230 may transmit information on the user and the information on the passenger to the deep learning module 250, and may transmit information processed by the deep learning module 250 to the database 240.

In the instant case, since the information on the genders and the ages of the user and the passenger is personal information, the controller 230 may infer the information on the genders and the ages of the user and the passenger from the deep learning module 250, without receiving the information on the genders and the ages of the user and the passenger from the user and the passenger.

According to various exemplary embodiments of the present invention, the controller 230 in the server 200 to manage the autonomous driving vehicle may set priority for the user, based on information on a request for the use of the autonomous driving vehicle by the user. For example, the controller 230 may set higher priority for a user rejecting riding together with the passenger, and may set lower priority for a user that wants riding together with the passenger. Furthermore, the controller 230 may set higher priority for a request for the transport of an article to be urgently delivered.

The controller 230 may control an autonomous driving vehicle based on the set priority. For example, the controller 230 may control the autonomous driving vehicle to drive toward the destination nonstop, with respect to the request for the use of the autonomous driving vehicle, which is set with the higher priority, and may control the autonomous driving vehicle to allow riding together with another person or to stop by a certain place, with respect to the request for the use of the autonomous driving vehicle which is set with the lower priority.

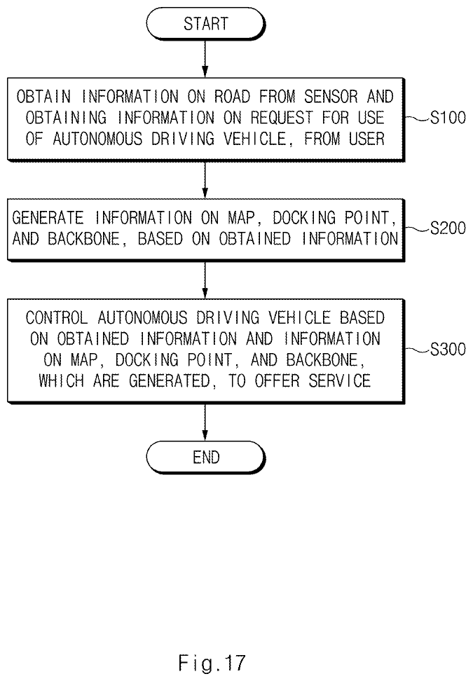

Hereinafter, a method for offering an autonomous driving vehicle service will be described with reference to FIGS. 17 to 23.

FIG. 17 is a flowchart illustrating a method for offering a service (autonomous driving vehicle service) of an autonomous driving vehicle by a server to manage the autonomous driving vehicle.

Referring to FIG. 17, the method for offering the autonomous driving vehicle service may include the steps of obtaining information on a road from a sensor and obtaining information on the request for the use of the autonomous driving vehicle, from the user (S100), generating information on a map, a docking point, and a backbone, based on the obtained information (S200), and controlling the autonomous driving vehicle based on the obtained information and the information on the map, the docking point, and the backbone, which are generated, to offer the service (S300).

In the step of obtaining information on the road from the sensor and obtaining information on the request for the use of the autonomous driving vehicle, from the user (S100), the information obtaining device 210 may obtain information on the road from the sensor and may obtain the request for the use of the autonomous driving vehicle, from the user.

In the step of generating the information on the map, the docking point, and the backbone, based on the obtained information (S200), the route generator 220 may generate information on the map, the docking point, and the backbone, based on the information on the road, which is obtained from the information obtaining device 210, and the information on the request for the use of the autonomous driving vehicle. For example, the map may include a grid map.

In the step of controlling the autonomous driving vehicle based on the obtained information and the information on the map, the docking point, and the backbone, which are generated to offer the service (S300), the controller 230 may control a plurality of autonomous driving vehicles to offer the service, based on the information on the map, the docking point, and the backbone, which are generated by the route generator 220, and information obtained from the information obtaining device 210. For example, the service offering by the plurality of autonomous driving vehicles may include at least one of a Logistics transport service, a people transport service, or a food delivery service. For another example, in the step of controlling the autonomous driving vehicle (S300), the controller 230 may transmit a command for starting driving and information on the driving to the vehicle.

According to various exemplary embodiments of the present invention, the controller 230 may control the autonomous driving vehicle, based on the information obtained from the information obtaining device 210 and information generated by the route generator 220, and may allow the autonomous driving vehicles to offer suitable services to the user.

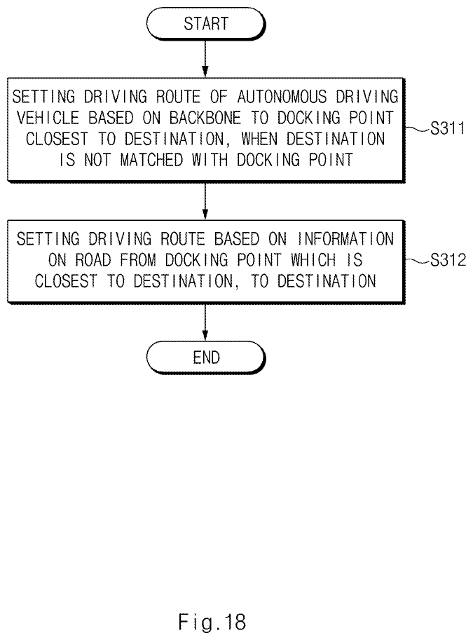

FIG. 18 is a flowchart illustrating a method for setting a route of an autonomous driving vehicle driving from a departure point to a destination of the user, by the server to manage the autonomous driving vehicle.

Referring to FIG. 18, the method for setting the route of the autonomous driving vehicle may include the steps of setting a driving route of the autonomous driving vehicle based on a backbone to a docking point closest to a destination, when the destination is not matched with the docking point (S311), and setting a driving route based on information on the road from the docking point which is closest to the destination, to the destination (S312). According to various exemplary embodiments of the present invention, S311 and S312 may be included in S300 of FIG. 17.

In the setting the driving route of the autonomous driving vehicle based on the backbone to the docking point closest to the destination, when the destination is not matched with the docking point (S311), the controller 230 may set the driving route based on the backbone to the docking point close to the destination, when setting the driving route of the autonomous driving vehicle and when the destination is not matched with the docking point.

In the step of setting the driving route based on information on the road from the docking point closest to the destination to the destination (S312), the controller 230 may set the driving route from a docking point closest to the destination to the destination, based on the information on the road, when setting the driving route of the autonomous driving vehicle. For example, the controller 230 may set the driving route of the autonomous driving vehicle from the docking point closest to the destination to the destination, based on at least one of information on a traffic volume of the road, information on a distance, or information on the gradient of the road. For another example, the controller 230 may set a route of the autonomous driving vehicle from the docking point closest to the destination to the destination, through gradient descent.

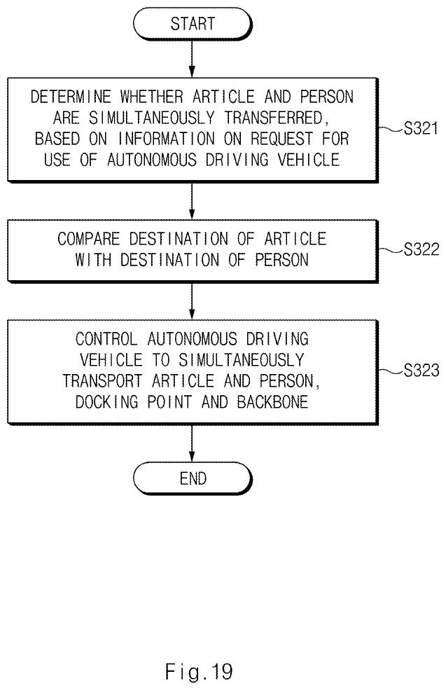

FIG. 19 is a flowchart illustrating a method for offering an autonomous driving vehicle service when an article and a person are simultaneously transported.

Referring to FIG. 19, the method for offering the autonomous driving vehicle service may include determining whether an article and a person are simultaneously transferred, based on the information on the request for the use of the autonomous driving vehicle (S321), comparing a destination of the article with a destination of the person (S322), and controlling the autonomous driving vehicle to simultaneously transport the article and the person, based on the docking point and the backbone (S323). According to various exemplary embodiments of the present invention, S300 of FIG. 17 may include S321, S322, and S323.

In the step of determining whether the article and the person are simultaneously transferred, based on the information on the request for the use of the autonomous driving vehicle (S321), the controller 230 may determine whether the article and the person are simultaneously transported, based on the information on the request for the use of the autonomous driving vehicle, which is obtained from the information obtaining device 210. For example, the controller 230 may determine the article and the person to be simultaneously transported, when a request for the transport of the article and the request for the use of the autonomous driving vehicle are made such that the transport of the article and the use of the autonomous driving vehicle are started from the same docking point. For another example, when a person requests the riding together with another person or an article, while the another person or the article is transported through the autonomous driving vehicle, or when the delivery of the article is performed together, the controller 230 may determine an article and a person to be simultaneously transported.

Meanwhile, the number of persons and the number of articles may be limited to the extent that the persons and the articles are able to be transported by the autonomous driving vehicle. In other words, the autonomous driving vehicle allows an “x” (x is a natural number equal to or greater than “1”) number of persons to simultaneously ride, and a “y” (y is a natural number equal to or greater than “1”) number of articles to simultaneously deliver.

In the step of controlling the autonomous driving vehicle to simultaneously transport the article and the person (S323), the controller 230 may compare destinations of the article and the person simultaneously transported with each other. For example, the controller 230 may arrange the destinations of the “x” number of persons and the “y” number of articles in order of closer distances. For another example, the controller 230 may group persons and articles having the same destinations by comparing the destinations of the “x” number of persons and the “y” number of articles with each other.

In the step of controlling the autonomous driving vehicle to simultaneously transport the article and the person, based on the docking point and the backbone (S323), the controller 230 may control the autonomous driving vehicle to simultaneously transport articles and persons, based on the docking point and the backbone. For example, the controller 230 may control the autonomous driving vehicle to transport the “x” number of persons and the “y” number of articles in order of closer distances. For another example, the controller 230 may control the autonomous driving vehicle to sequentially transport the groups, which have the same destination, including the “x” number of persons and the “y” number of articles. For another example, when it is determined as being ineffective that the autonomous driving vehicle drives to the destinations of the “x” number of persons and the “y” number of articles, the controller 230 may control the autonomous driving vehicle such that some persons transfer to another autonomous driving vehicle at the docking point, and may control the autonomous driving vehicle such that some articles are transferred to another autonomous driving vehicle for transport.

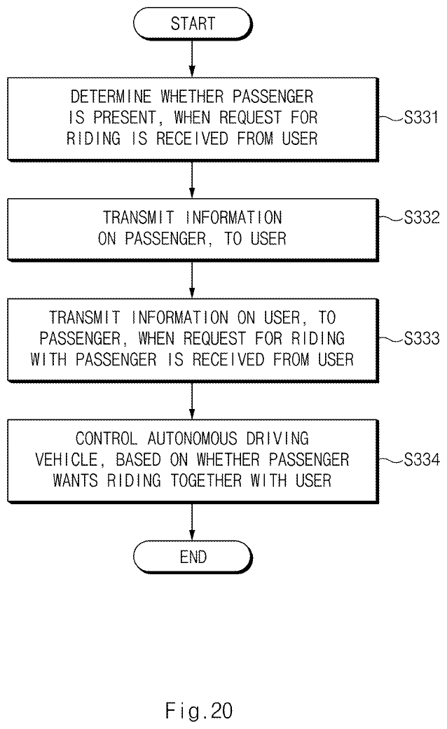

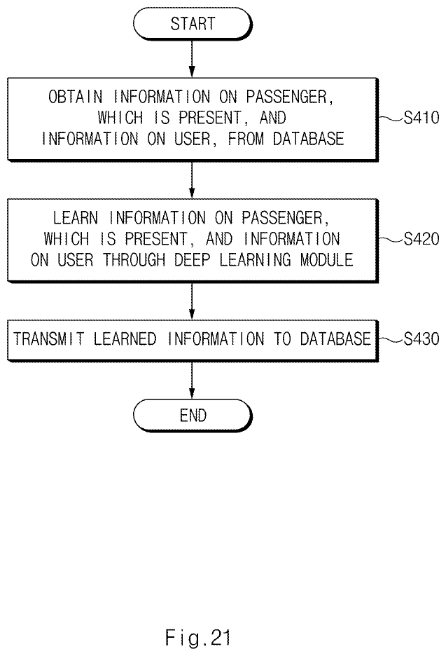

Hereinafter, the case that a plurality of persons and a plurality of articles are transported will be described with reference to FIGS. 20 and 21.

FIG. 20 is a view exemplarily illustrating that an article is transported between autonomous driving vehicles at a docking point.

Referring to FIG. 20, a first vehicle “V1” and a second vehicle “V2” may meet with each other at a docking point. For example, the first vehicle “V1” may be an autonomous driving vehicle for Kang-Nam, and the second vehicle “V2” may be an autonomous driving vehicle for Kang-Buk. Furthermore, the destination of person 1 may be Kang-Nam, and the destinations of person 2 and article “A” may be Kang-Buk. Since the first vehicle “V1” is an autonomous driving vehicle for Kang-Nam, the case that the article “A” is transported by the first vehicle V1 may be inefficient. In other words, the controller 230 controls the first vehicle V1 and the second vehicle “V2” such that the article “A” is transferred to the second vehicle “V2” going to Kang-Buk from the docking point.

Meanwhile, although FIG. 20 illustrates one article, and two persons, the present invention is not limited thereto. In other words, the controller 230 may control a plurality of autonomous driving vehicles such that a plurality of articles may be transferred to another autonomous driving vehicle at the docking point, or a plurality of persons may be transferred to another autonomous driving vehicle.

FIG. 21 is a view exemplarily illustrating that an autonomous driving vehicle transports a plurality of persons and a plurality of articles.

In the instant case, the third vehicle “V3” may arrive at Singil Station from Gangnam Station via Sadang Station, and may arrive at Gangnam Station from Singil Station via Sadang Station. The third vehicle “V3” may transport a plurality of articles and a plurality of people while driving.

For example, the controller 230 may control the third vehicle “V3” to start transporting the article “A” and the person 1 at Gangnam Station. The controller 230 may control the third vehicle “V3” to go through Sadang Station when the destination of the article “A” is Sadang Station and the departure point of the article “B” is Sadang Station, and may get off the article “A” and board the article “B” when arriving at the Sadang Station. When the destinations of person 1 and article “B” are Singil Station, the controller 230 may control the third vehicle “V3” to drive toward Singil Station, and may get off person 1 and article “B” upon arriving at Singil Station.

For another example, the controller 230 may board article “C” and person 2 on the third vehicle “V3” at Singil station. When the destination of article “C” is Sadang station, the controller 230 may control the third vehicle “V3” to move to Singil station, and may get off article “C” at Singil station. The controller 230 may board person 3 at Singil station, may control the third vehicle “V3” to move to Kang-Nam, may get off person 2 and person 3 at Kang-Nam, and may control the third vehicle “V3” to stand by at Kang-Nam

In other words, the controller 230 may simultaneously transport a plurality of persons and a plurality of articles. However, the number of articles and the number of persons that are able to board on the third vehicle “V3” controlled by the controller 230 are not limited to that illustrated in FIG. 21. Furthermore, when the persons or the articles get off the third vehicle “V3”, a place, in which the persons or the articles get off, may not be destinations, but may be a place for transfer at a docking point.

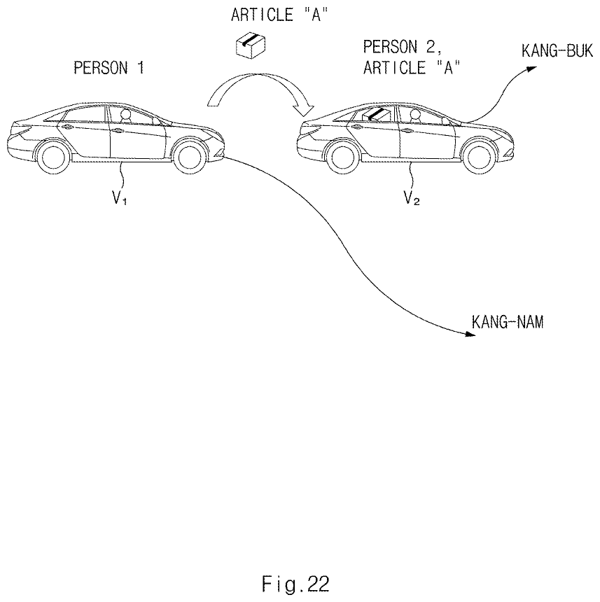

Hereinafter, a method for offering the together-riding service of a person in a method for offering in an autonomous driving vehicle service will be described with reference to FIG. 22.

FIG. 22 is a view exemplarily illustrating a method for offering a together-riding-service in a method for offering an autonomous driving vehicle service.

Referring to FIG. 22, the method for offering the autonomous driving vehicle service may include the steps of determining whether a passenger is present, when a request for riding is received from a user (S331), transmitting information on the passenger, to the user (S332), transmitting information on the user, to the passenger, when a request for riding together with the passenger is received from the user (S333), and controlling the autonomous driving vehicle, based on whether the passenger wants riding together with the user (S334). According to various exemplary embodiments of the present invention, S300 of FIG. 17 may include S331, S332, and S334.

In the determining whether the passenger is present, when a request for riding is received from the user (S331), the information obtaining device 210 may obtain the information on the request for the riding by the user. When the request for the riding is received from the user, the controller 230 may determine whether the passenger is present.

In the transmitting of the information on the passenger to the user (S332), when the passenger is present, the controller 230 may transmit information on the passenger which is present, to the user. For example, the controller 230 may request confirmation for whether the passenger wants riding together with the user while transmitting the information on the passenger.

In the transmitting information on the user, to the passenger, when the request for riding together with the passenger is received from the user (S333), the controller 230 may transmit information on the user to the passenger, which is present, when the request for the riding together with the passenger is received from the user. For example, the controller 230 may transmit a confirmation request for whether the passenger wants riding together with the user while transmitting the information on the user. For another example, the controller 230 may allocate another autonomous driving vehicle to the user, when the user does not want the riding together with the passenger.

In the controlling of the autonomous driving vehicle, based on whether the passenger wants riding together with the user (S334), the controller 230 may control the autonomous driving vehicle to ride the user thereon, when the passenger, which is present, wants the riding together with the user. For example, the controller 230 may control an autonomous driving vehicle to move around a user having the using request. For another example, the controller 230 may allocate another autonomous driving vehicle to the user, when the passenger, which is present, does not want the riding together with the user.

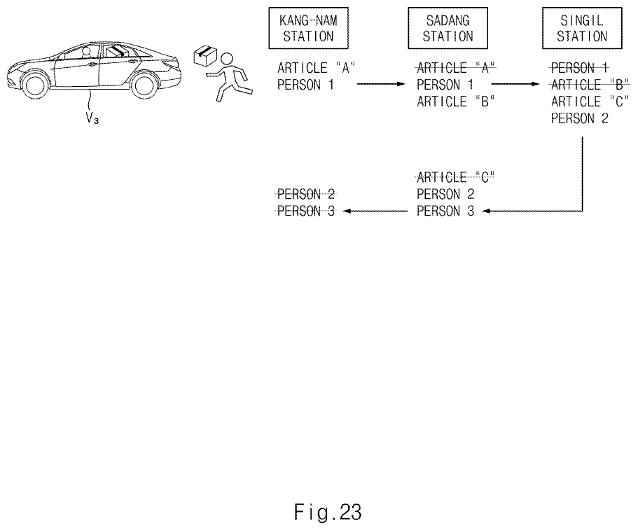

FIG. 23 is a flowchart illustrating a step which is further included in a method for offering an autonomous driving vehicle service.

Referring to FIG. 23, the method for offering the autonomous driving vehicle service may further include obtaining information on the passenger, which is present, and information on the user, from a database (S410).

In the obtaining of information on the passenger, which is present, and the information on the user, from the database (S410), the controller 230 may obtain the information on the passenger, which is present, and the information on the user, from the database 240. For example, the information on the passenger, which is present, and the information on the user may include at least one of a gender, an age, or a riding manner of the passenger which is present.

According to various exemplary embodiments of the present invention, the method for offering the autonomous driving vehicle service may further include learning the information on the passenger, which is present, and the information on the user through the deep learning module (S420), and transmitting the learned information to the database (S430).

In the learning of the information on the passenger, which is present, and the information on the user through the deep learning module (S420), the deep learning module 250 may obtain the information on the user and the information on the passenger, from the controller 230 and may learn the obtained information. For example, the information obtained by the deep learning module 250 may include the information on the ages, the genders, images, or sounds of the user and the passenger which is present.

In the transmitting of the learned information to the database (S430), the deep learning module 250 may transmit the learned information to the database 250. For example, the database 250 may receive and store the learned information. Thereafter, when the same user and the same passenger are present, the database 250 may transmit the stored information to the controller 230 to support the autonomous driving vehicle such that the autonomous driving vehicle service is offered.

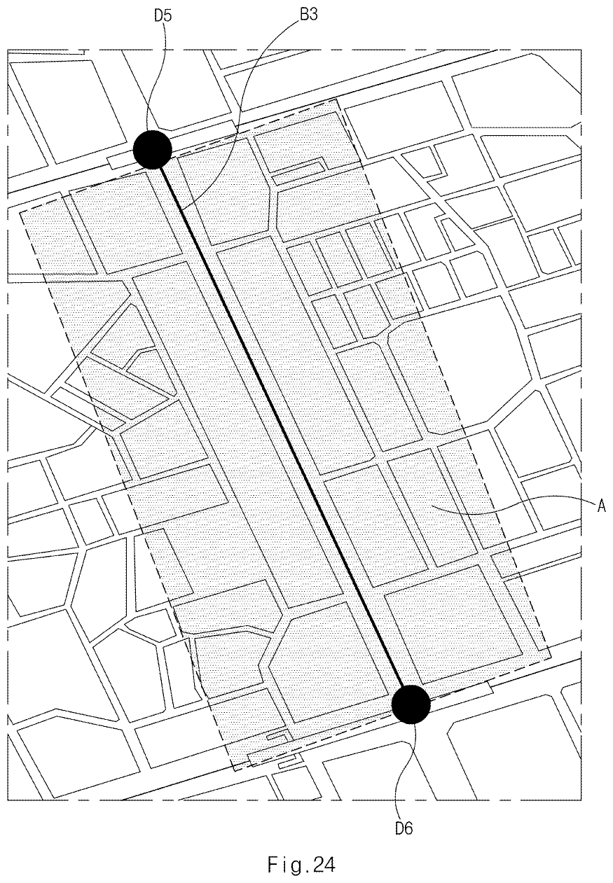

FIG. 24 is a block diagram illustrating a system to manage an autonomous driving vehicle.

Referring to FIG. 24, a system 1000 for managing an autonomous driving vehicle may include a sensor 1100, a terminal 1200, a server 1300, and a plurality of autonomous driving vehicles 1400.

The sensor 1100 may obtain information related to a road. For example, the sensor 1100 may be substantially the same as the sensor 11 of FIG. 1.

The terminal 1200 may receive a request for the use of a plurality of autonomous driving vehicles 1400 by a user. For example, the terminal 1200 may be substantially the same as the terminal 12 of FIG. 1.

The server 1300 may obtain information related to a road from the sensor 1100, and may obtain information related to a request for use of an autonomous driving vehicle from the terminal 1200. According to various exemplary embodiments of the present invention, the server 1300 may generate information on a map, a docking point, and a backbone, based on the obtained information. Furthermore, the server 1300 may control a plurality of autonomous driving vehicles 1400, based on information on the road, information on a request for the use of the autonomous driving vehicle, and information on a map, which is generated, a docking point, and a backbone. For example, the server 1300 may control the plurality of autonomous driving vehicles 1400 by transmitting a command for starting driving or information on driving to the plurality of autonomous driving vehicles 1400.

According to various exemplary embodiments of the present invention, the server 1300 may include the docking point generating module 15 and the inter-docking point backbone generating module 16. According to various embodiments, the server 1300 may further include the database 17 and the deep learning module 18 of FIG. 1. In other words, the server 1300 may be substantially the same as the server 14 of FIG. 1.

The plurality of autonomous driving vehicles 1400 may drive by receiving information on the starting of the driving or the information on the driving of the vehicle. For example, the plurality of autonomous driving vehicles 1400 may provide various services to users under the control of the server 1300. For another example, the plurality of autonomous driving vehicles 1400 may be substantially the same as the plurality of autonomous driving vehicles 13 of FIG. 1.

As described above, according to various exemplary embodiments of the present invention, the apparatus of generating the route of the autonomous driving vehicle may generate a route allowing the autonomous driving vehicle to efficiently drive.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of generating a route of an autonomous driving vehicle, the apparatus comprising:
an information obtaining device configured to obtain information on a road and information on a demand amount of the autonomous driving vehicle; and
a controller configured to:
generate a map based on the information obtained from the information obtaining device; and
generate a docking point based on the generated map.

2. The apparatus of claim 1, wherein the information on the road includes:
at least one of information on a real-time road traffic volume of the road, information on construction of the road, information on an accident section of the road, in which an accident occurs, information on a map of the road, information on a road width of the road, a number of lanes on the road, a number of crossroads on the road, or a number of routes, which allow movement to a nearby area, of the road.

3. The apparatus of claim 2, wherein the controller is configured to:
divide the map of the road by a plurality of cells; and
generate the map by scoring the plurality of cells, based on the information on the road and the information on the demand amount.

4. The apparatus of claim 3, wherein the controller is configured to:
generate at least one of a first grid map based on the real-time traffic volume of the road, a second grid map based on the demand amount for the autonomous driving vehicle, or a third map based on accessibility of the road, and
wherein the accessibility of the road is determined based on at least one of the information on the road width of the road, the number of the lanes on the road, the number of the crossroads on the road, or the number of the routes, which allow movement to the nearby area, of the road.

5. The apparatus of claim 4, wherein the controller is configured to:
generate a final map based on scores of the plurality of cells, which are applied to the first map, the second map, and the third map, and a weight for each situation.

6. The apparatus of claim 5, wherein the controller is configured to:
set the weight through one of a machine learning algorithm or a deep learning algorithm.

7. The apparatus of claim 5, wherein the controller is configured to:
compare the scores of the plurality of cells included in the final grid map with a threshold value; and
generate, as the docking point, at least one cell having a score higher than the threshold value among the cells included in the final grid map with.

8. The apparatus of claim 7, wherein the controller is configured to:
generate a backbone, which is a shortest route between docking points, based on the docking points.

9. The apparatus of claim 8, wherein the controller is configured to:
generate a backbone through one of a machine learning algorithm, a deep learning algorithm, or an algorithm of determining the shortest route.

10. The apparatus of claim 8, wherein the controller is configured to:
regenerate the map, the docking point, and the backbone, when arrival of the autonomous driving vehicle at the docking point is determined as being difficult, based on at least one of the construction information of the road or the information on the accident section of the road.

11. A method for offering a service by an autonomous driving vehicle, the method comprising:
obtaining information on a road from a sensor and obtaining information on a request for use of the autonomous driving vehicle, from a user;
generating information on a map, a docking point, and a backbone, based on the obtained information; and
controlling the autonomous driving vehicle based on the obtained information and the information on the map, the docking point, and the backbone, which are generated, to offer the service by the autonomous driving vehicle.

12. The method of claim 11, wherein the controlling of the autonomous driving vehicle to offer the service by the autonomous driving vehicle includes:
transmitting a command for starting driving and information on the driving to the autonomous driving vehicle.

13. The method of claim 11, wherein the information on the request for the use of the autonomous driving vehicle includes:
a destination of the user, and
wherein the offering of the service by the autonomous driving vehicle by controlling the autonomous driving vehicle include:
setting a driving route of the autonomous driving vehicle based on the backbone to a docking point closest to the destination, when the destination is not matched with the docking point; and
setting the driving route based on information on the road from the docking point, which is closest to the destination, to the destination.

14. The method of claim 13, wherein the setting of the driving route based on the information on the road from the docking point closest to the destination to the destination include:
setting a route of the autonomous driving vehicle from the docking point, which is closest to the destination, to the destination, through gradient descent, based on the information on the road.

15. The method of claim 11, wherein the controlling of the autonomous driving vehicle to offer the service includes:
determining whether an article and a person are simultaneously transported based on the information on the request for the use of the autonomous driving vehicle;
comparing a destination of the article with a destination of the person; and
controlling the autonomous driving vehicle to simultaneously transport the article and the person, based on the docking point and the backbone.

16. The method of claim 11, wherein the controlling of the autonomous driving vehicle to offer the service includes:
setting a priority for the user, based on the information on the request for the use of the autonomous driving vehicle by the user; and
controlling the autonomous driving vehicle based on the priority.

17. The method of claim 11, wherein the information on the request for the use of the autonomous driving vehicle include:
information on a riding request by the user, and
wherein the controlling of the autonomous driving vehicle to offer the service includes:
determining whether a passenger is present, when the riding request is received from the user;
transmitting information on the passenger present to the user;
receiving and determining whether the user wants riding together with the passenger;
transmitting information on the user to the passenger present, when a request for riding together with the passenger is received from the user; and
controlling the autonomous driving vehicle, based on whether the passenger wants riding together with the user.

18. The method of claim 17, further including:
obtaining the information on the passenger and the information on the user from a database.

19. The method of claim 18, further including:
learning the information on the passenger and the information on the user, through a deep learning module; and
transmitting the learned information to the database.

20. A system to manage an autonomous driving vehicle, the system comprising:
a plurality of autonomous driving vehicles;
a sensor configured to obtain information on a road;
a terminal configured to receive a request for use of the plurality of autonomous driving vehicles by a user; and
a server configured to:
obtain information on the road from the sensor;
obtain information on the request for the use of the autonomous driving vehicles from the terminal;
generate information on a map, a docking point, and a backbone; and
control the plurality of autonomous driving vehicles, based on the information on the road, the information on the request for the use of the autonomous driving vehicle, and the information on the map, the docking point, and the backbone.
